(19) United States
(12) Patent Application Publication
(10) Pub. No.: US 2004/0011891 A1
(43) Pub. Date: Jan. 22, 2004

(54) Fuel injector having two-way valve control

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/362,886

(22) PCT Filed: Jul. 4, 2002
(86) PCT No.: PCT/DE02/02431

(30) Foreign Application Priority Data
Jul. 4, 2001 (DE) 101 32 248.8

(51) Int. Cl. F02M 59/00

(52) U.S. Cl. 239/533.2

(57) ABSTRACT

The invention relates to a fuel injector for injecting fuel into the combustion chamber of an internal combustion engine, with a nozzle needle (3). The pressure increase/pressure decrease in the control chamber (2) can be used to actuate this nozzle needle (3) in the injector body (1) between a position that unblocks injection openings and a position that closes injection openings. The leakage oil side of the control chamber (2) can be acted on via a pressure relief line (6) containing an outlet throttle (7) and via a high-pressure side inlet (8) with an inlet throttle (9), which simultaneously acts on a nozzle chamber (15) in the injector body (1) with pressurized fuel. The pressure change in the control chamber (2) of the injector body (1) takes place by means of a first on-off valve (21) and an additional on-off valve (27), wherein the first on-off valve (21) has an initial stroke (33) in the switching direction (32).

### TECHNICAL FIELD

In high-pressure injection systems for direct-injecting internal combustion engines, the combustion chambers of the engine are associated with fuel injectors that are supplied with highly pressurized fuel. In the fuel injectors, 3/2-way valve can be used, which are installed together with a 2/2-way valve. An interconnection of a 3/2-way valve and a 2/2-way valve is common practice, but involves high costs with regard to the matching of the valves to each other.

### PRIOR ART

DE 197 01 879 A1 relates to a fuel injection device for internal combustion engines. It includes a common high-pressure accumulation chamber (common rail) that can be filled with fuel by a high-pressure pump. This high-pressure accumulation chamber is connected via injection lines to injection valves that protrude into the combustion chamber of the engine to be fed. The opening and closing motions of these injection valves are respectively controlled by an electrically triggered control valve, which is embodied as a 3/2-way valve. This valve connects a high-pressure conduit, which feeds into an injection opening of the injection valve, to the injection line or a pressure relief line. The control valve element of the control valve is provided with a hydraulic working chamber that can be filled with high fuel pressure fuel and can be opened into a pressure relief conduit in order to adjust the set position of the control valve element of the control valve. The working chamber of the control valve element is embodied as a hydraulic working chamber, which can be filled with high fuel pressure, acts on the control valve element counter to a hydraulic opening force engaging it in the closing direction of a through flow cross section between an injection line and the high-pressure conduit, and can be opened into a pressure relief chamber. To that end, the control valve has an obliquely extending throttle bore passing through it and by means of this throttle, is continually acted on by highly pressurized fuel. The inlet throttle, which is integrated into the control valve element and is embodied in a smaller throttle cross section, is expensive to manufacture in terms of its initial production and subsequent fine machining.

DE 197 44 518 A1 has disclosed a reduced-mass fuel injection valve for internal combustion engines. This valve includes a valve body, which is contained in an axially movable fashion in a valve body, and which, on its end oriented toward the combustion chamber of the internal combustion engine, has a conical valve sealing surface that cooperates with a conical valve seat surface on the valve body in order to control an injection cross section. By means of an internal guide, the valve element is guided in a sliding fashion on a pin of a stationary insert body. The opening motion and stroke motion of the valve body is advantageously limited by means of mechanical stroke stop surfaces on the pin of a stationary insert body. The control valve that opens the control chamber into a pressure-relief chamber can be embodied as a 2/2-way valve, but 2/3-way, 3/2-way, or 3/3-way valves can alternatively also be used.

### DESCRIPTION OF THE INVENTION

The embodiment according to the invention makes it possible to produce a stroke/pressure-controlled fuel injector with a simple design. An initial stroke, which is provided between the 2/2-way valves, makes it possible to switch one of the 2/2-way valves, i.e. the valve situated on the pressure reservoir side, without the second 2/2-way valve being actuated and unblocking a leakage oil outlet. Only when an initial stroke has been exceeded, viewed in the switching direction of the valve actuator, is the second 2/2-way valve switched into its open position; until then, the control chamber of the fuel injector embodied according to the invention remains closed off from the low pressure side, i.e. the leakage oil outlet, and the nozzle needle remains in its closed position due to the high pressure level prevailing in the control chamber.

However, if the initial stroke path between the first 2/2-way valve and the second 2/2-way valve has been exceeded, then the second 2/2-way valve opens in relation to the leakage oil and the fuel injector is stroke-controlled. On the other hand, if the actuator switches both of the 2/2-way valves directly into their open positions, then the fuel injector operates in a pressure-controlled manner. By means of the design of the throttle elements, which are particularly easy to produce for technical manufacturing reasons and are intended for both relieving pressure in and exerting pressure on the control chamber of the fuel injector, it is necessary to guarantee that the pressure relief of the latter is assured. To this end, the outlet throttle is designed with a larger cross section and permits a greater fuel through flow than the inlet throttle that is contained in an inlet, which is connected to a high-pressure source and can be opened by means of the first 2/2-way valve.

The sealing spring, which acts on the nozzle needle in the injector housing and is preferably embodied as a spiral spring, unblocks the opening of the injection nozzle after a pressure P_{D,OE} has been reached that corresponds to the nozzle opening pressure. Once the opening pressure level has been reached, the pressure that has built up in the nozzle chamber acts on the pressure shoulder passing through the nozzle chamber, counter to the closing force of the sealing spring.

### DRAWING

The invention will be explained in detail in conjunction with the drawing.

The sole FIGURE depicts a schematic view of an injector body, whose control chamber and nozzle chamber can be acted on by two 2/2-way valves that can be actuated by means of an actuator.

### EMBODIMENTS VARIANTS

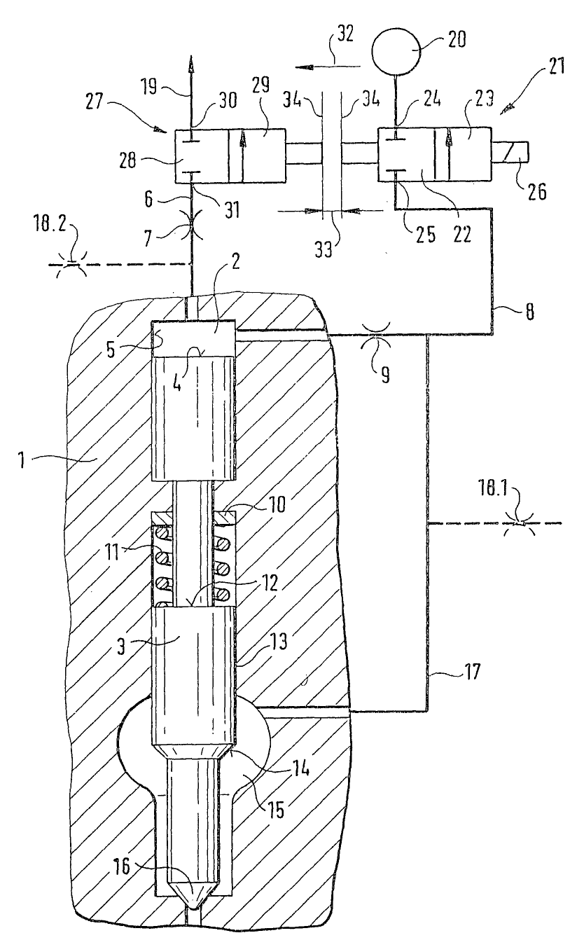

FIG. 1 shows a schematic depiction of a fuel injector with a nozzle chamber and a control chamber, with two 2/2-way valves that can be actuated by means of an actuator, for example a piezoelectric actuator.

A control chamber 2 is provided in an injector body 1 of a fuel injector for injecting fuel into the combustion chamber of an internal combustion engine. This control chamber 2 is used to actuate a nozzle needle 3, only depicted schematically here, in the injector body 1. The control chamber 2 inside the injector body 1 is defined by a control chamber wall 5 in addition to the end face 4.

A pressure relief line 6, which contains an outlet throttle element 7, leads from the control chamber 2 to an on-off valve 27. The control chamber 2 inside the injector body 1 is supplied with highly pressurized fuel via a high-pressure side inlet 8 that has an inlet throttle element 9 integrated into it. The high-pressure side inlet 8, which extends from the control chamber 2 to a high-pressure source 20 depicted schematically here, contains a first on-off valve 21. A nozzle chamber inlet 17 branches off from the high-pressure side inlet 8, and makes it possible for a nozzle chamber 15 encompassing the nozzle needle 3 to likewise be acted on with highly pressurized fuel.

The nozzle needle 3 is supported in the injector body 1 of the fuel injector by means of a spring element 11. To that end, the spring element 11 is supported against a stop ring in the injector body 1, while the end of the spring element 11 oriented away from the stop ring 10 is supported against a shoulder 12 of the nozzle needle 3. The nozzle needle 3 is provided with a pressure shoulder 14 in the region in which it is encompassed in annular fashion by the nozzle chamber 15. At the end of the nozzle needle 3 oriented toward the combustion chamber, the nozzle needle 3 can be provided with a conically tapering end 16, which opens and closes the injection openings that are not shown here and extend into the combustion chamber of the internal combustion engine, as a function of the stroke motion of the nozzle needle 3 in the injector body 1. The nozzle chamber inlet 17 and the pressure relief line 6 extending to the low-pressure side 19 of the fuel injector can each be associated with throttle elements that serve as additional leakages. In position 18.1, the nozzle chamber inlet 17 can be associated with a throttle element in order to provide an additional leakage; in an alternative embodiment, in position 18.2, this throttle element can also be associated with the relief line 6 into the low-pressure region 19 of the fuel injector.

From the high-pressure source 20 depicted schematically here, the high-pressure side inlet 8 extends to the control chamber 2, wherein the inlet 8, before an inlet throttle element 9 provided in it, branches off into a nozzle chamber inlet 17, via which the control chamber 15, which encompasses the nozzle needle 3 in the region of the pressure shoulder 14, is acted on with highly pressurized fuel. The high-pressure side inlet is provided with a first on-off valve 21, which is preferably embodied as a 2/2-way valve. The first on-off valve 21 can be switched into a closed position 22 and an open position 23. The part of the high-pressure inlet 8 oriented toward the control chamber 2 is labeled with the reference numeral 25; the reference numeral 24 identifies the side of the first on-off valve 21 oriented toward the high-pressure source 20, which on-off valve 21 is preferably embodied as a 2/2-way valve. The first on-off valve can be actuated by means of an actuator 26, which can be embodied on the one hand as a piezoelectric actuator 26 or on the other hand as a solenoid valve.

The above-mentioned first on-off valve 21, which is preferably embodied as a 2/2-way valve, is disposed opposite another on-off valve 27, which can also preferably be embodied as a 2/2-way valve. This additional valve assumes a closed position labeled with the reference numeral 28 and an open position labeled with the reference numeral 29. The side of the additional on-off valve 27 oriented toward the control chamber 2 is labeled with the reference numeral 31, while the side of the additional on-off valve 27 oriented toward the low-pressure region of the fuel injector is labeled with the reference numeral 30. The pressure relief line 6 extends away from this side toward the low-pressure region 19 of the fuel injector according to the schematic depiction in FIG. 1.

An initial stroke 33 is set between the first on-off valve 21, preferably embodied as a 2/2-way valve, and the additional on-off valve 27. The initial stroke 33 indicates the distance between two contact surfaces 34, which are embodied on the movable valve bodies of the first on-off valve 21, preferably embodied as a 2/2-way valve, and the additional, second on-off valve 27. The actuator 26, which is associated with the first on-off valve and can either be a piezoelectric actuator or a solenoid valve, actuates the first on-off valve 21 and the additional on-off valve 27 in the switching direction 32, bridging over the initial stroke 33 set between the contact surfaces 34.

High fuel pressure is continuously present against the side 24 of the first on-off valve 21 oriented toward the high-pressure source 20, which valve is preferably embodied as a 2/2-way valve. The leakage oil pressure level is continuously present against the additional on-off valve 27, which in a manner analogous to the first on-off valve 21, can preferably be embodied as a 2/2-way valve. If current is supplied to the actuator 26, which is associated with the first on-off valve 21 and the additional on-off valve 27 and is embodied for example as a piezoelectric actuator, then the first on-off valve 21 moves from its closed position 22 shown in FIG. 1 into the open position labeled with the reference numeral 23. The pressure prevailing in the high-pressure source 20 consequently acts on the high-pressure inlet 8 and therefore possibly on the control chamber 2 and, via the throttle chamber inlet 17, acts on the nozzle chamber 15 encompassing the nozzle needle 3. As long as the actuator 26 is actuated in the switching direction 32, in such a way that the initial stroke 33 set between the contact surfaces 34 is not exceeded, then the additional on-off valve 27 remains in the closed position 28, i.e. there is no pressure relief of the control chamber 2 via the pressure relief line 6 into the low-pressure side 19 of the injector.

However, if an opening of the second on-off valve 27 from its closed position 28 into its open position 29 takes place in this state, then a connection is produced between the pressure relief line 6 and the low-pressure side 19 of the fuel injector, i.e. the injector then operates in a stroke-controlled manner. In this connection, it is important that the outlet throttle 7 contained in the pressure relief line 6 and the inlet throttle 9 contained in the high-pressure inlet 8 are matched so that these throttle elements 7, 9 assure a pressure relief of the control chamber/nozzle needle system of the injector.

However, if the actuator 26 associated with the first on-off valve 21, for example a piezoelectric actuator or a solenoid valve, is actuated in the switching direction 32 so that the first on-off valve 21 is switched over into its open position 23 and the additional on-off valve 27 is also switched over into its open position 29, then the control chamber 2 in the injector body 1 is short-circuited and the fuel injector operates in a pressure-controlled manner. The closing force of the spring element between the stop ring 10 and the shoulder 12 on the nozzle needle 3 is dimensioned so that the needle is set to the required nozzle opening pressure. The sealing spring 11, which in this instance functions as a nozzle holding spring, functions as a nozzle holding spring when the first on-off valve 21 is switched open and the additional on-off valve 27 is also switched open and, in the pressure-controlled operating mode of the fuel injector according to the depiction in FIG. 1, unblocks the injection openings in the cone region 16 of the nozzle needle 3 once the nozzle opening pressure against the pressure shoulder 14 has been exceeded.

The advantages that can be achieved with the embodiment variants outlined above include, among others, the fact that it is possible to produce a very simply designed fuel injector. Through the use of two 2/2-way valves as a first on-off valve 21 and an additional on-off valve 27, in which an initial stroke 33 in the switching direction 32 is set between these two on-off valves 21 and 27, the fuel injector according to the invention can be operated both as a stroke-controlled injector and as a pressure-controlled injector. Otherwise, these operating modes can only be achieved by means of a 3/2-port on-off valve in combination with a 2/2-way valve, which incurs a higher cost.

Providing additional leakage throttles at the positions 18.1 and 18.2 makes it possible to vary the design ratio of the outlet throttle 7 contained in the pressure relief line 6 and the throttle element 9 contained in the high-pressure side inlet 8 so that it is possible to assure that a pressure relief of the high-pressure side of the fuel injector takes place at all times.

1. A fuel injector for injecting fuel into the combustion chamber of an internal combustion engine, with a nozzle needle (3), in which the pressure increase/pressure decrease in a control chamber (2) can be used to actuate this nozzle needle (3) in the injector body (1) between a position that unblocks injection openings and a position that closes injection openings, and in which the leakage oil side of the control chamber (2) can be acted on via a pressure relief line (6) containing an outlet throttle (7) and via a high-pressure side inlet (8), which simultaneously supplies a nozzle chamber (15) with highly pressurized fuel, wherein a first on-off valve (21) is disposed in the high-pressure inlet (8), before it branches off into the control chamber inlet and the nozzle inlet (17), and an additional on-off valve is disposed in the outlet from the control chamber (2), characterized in that a common actuator (26) can actuate the on-off valves (21, 27) in the switching direction (32), wherein the first on-off valve (21) has an initial stroke (33) in the switching direction (32) in relation to the other on-off valve (27).

2. The fuel injector according to claim 1, characterized in that the first on-off valve (21) and the second on-off valve (27) are each embodied as 2/2-way valves.

3. The fuel injector according to claim 1, characterized in that the nozzle needle (3) is acted on by a spring element (11) whose closing force is set to the nozzle opening pressure p_{T,OE}.

4. The fuel injector according to claim 1, characterized in that the actuator (26) is embodied as a piezoelectric actuator.

5. The fuel injector according to claim 1, characterized in that the actuator (26) is embodied as a solenoid valve.

6. The fuel injector according to claim 1, characterized in that in the open position (23) of the first on-off valve (21), the control chamber (2) and the nozzle chamber (15) are connected via a high-pressure inlet (8, 17) to the high-pressure source (20), but the nozzle needle (3) is still closed.

7. The fuel injector according to claim 6, characterized in that upon further actuation of the first on-off valve (21) beyond the initial stroke (33), the additional on-off valve (27) is moved into the open position (29) and the injector is stroke-controlled.

8. The fuel injector according to claim 1, characterized in that upon actuation of the first on-off valve (21) and the additional on-off valve (27) in the switching direction (32), both of the on-off valves (21, 27) travel into the open position (23, 29), the control chamber (2) is no longer effective, and the injector is pressure-controlled.
